(19) United States
(12) Patent Application Publication
(10) Pub. No.: US 2010/0248080 A1
(43) Pub. Date: Sep. 30, 2010

(54) FUEL COLLECTION DEVICE

(75) Inventors: Kei MATSUOKA, Kawasaki-shi (JP); Yoshiyuki Isozaki, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/636,018

(22) Filed: Dec. 11, 2009

(30) Foreign Application Priority Data
Mar. 26, 2009 (JP) P2009-076911

(51) Int. Cl. H01M 2/00

(52) U.S. Cl. 429/513

(57) ABSTRACT

A fuel collection device detachably attached a fuel cell, the fuel cell having: a power generation unit generating power by chemically reacting a fuel; a fuel flow path supplying the fuel to the power generation unit; and a circulation pump circulating the fuel in the fuel flow path, the fuel collection device includes: a collection tank connected to the fuel flow path, and collecting the fuel in the fuel flow path by driving the circulation pump; and an air supplier connected to the fuel cell, and supplying an air to the power generation unit.

### CROSS REFERENCE TO RELATED APPLICATIONS AND INCORPORATED BY REFERENCE

The application is based upon and claims the benefit of priority from the prior Japanese Patent Applications No. P2009-76911, filed on Mar. 26, 2009; the entire contents of which are incorporated herein by reference.

### BACKGROUND OF THE INVENTION

1. Field of the Invention

The present invention relates to a fuel collection device for collecting a fuel from a fuel cell.

2. Description of the Related Art

At present, as a power supply or the like for using a portable electronic instrument continuously for a long time, a direct methanol fuel cell (DMFC) that generates power by directly using methanol is developed. As a type of this fuel cell, there is one to which a fuel cartridge filled with the methanol is detachably attached so as to make it possible to generate the power for a long time. In the case where such fuel in the fuel cartridge runs out, the fuel cartridge is replaced by a new fuel cartridge, whereby the power can be generated continuously.

If the fuel remains in an inside of the fuel cell when the fuel cell is disassembled in order to check the inside of the fuel cell, then in some case, the fuel reacts with oxygen and generates heat on an electrode portion, or a checker is exposed to the fuel that is harmful to the human body. Moreover, if the fuel remains in the inside of the fuel cell when the fuel cell is stored for a long period without being used, then in some case, a fuel cell performance loss in terms of fuel consumption, output, durability and the like is brought about owing to accumulation of water, the fuel or a byproduct of the fuel, or a failure of the fuel cell occurs owing to a deterioration of materials which compose the instrument. Furthermore, if the fuel remains in the inside of the fuel cell when the fuel cell is transported by air while being left in an aircraft cargo compartment, then in some case, breakage of an electrode or a fuel flow path owing to fuel freezing occurs since the fuel cell is left in an environment where a pressure and a temperature are low. Still further, if the fuel remains in the inside of the fuel cell when the fuel cell is thrown out, then in some case, the fuel that is harmful to the human body flows out to a waste disposal site, or an operator in charge of waste disposal is exposed to this harmful fuel. Hence, in the case where the fuel cell is disassembled, stored, transported, thrown out and so on, it is necessary to collect the fuel from the inside of the fuel cell in advance.

As a technique for collecting the fuel from the inside of the fuel cell, a fuel supply device (fuel cartridge) , which includes a fuel injection path through which injects fuel into the fuel cell, a fuel discharge path through which discharges the fuel in the inside of the fuel cell, and a fuel collection chamber into which collects the discharged fuel, is disclosed in JP-A 2007-227198 (KOKAI). In this fuel supply device, such pressurized fuel is injected into the fuel cell through the fuel injection path, the fuel remaining in the inside of the fuel cell is pushed out by the injected fuel, and the fuel thus pushed out is collected into the fuel collection chamber through the fuel discharge path. However, in the invention described in JP-A 2007-227198 (KOKAI), the fuel is newly supplied to the fuel cell when the fuel remaining in the inside of the fuel cell is collected. Accordingly, the fuel in the inside of the fuel cell cannot be discharged completely.

### SUMMARY OF THE INVENTION

An aspect of the present invention inheres in a fuel collection device detachably attached a fuel cell, the fuel cell having: a power generation unit generating power by chemically reacting a fuel; a fuel flow path supplying the fuel to the power generation unit; and a circulation pump circulating the fuel in the fuel flow path, the fuel collection device including: a collection tank connected to the fuel flow path, and collecting the fuel in the fuel flow path by driving the circulation pump; and an air supplier connected to the fuel cell, and supplying an air to the power generation unit.

Another aspect of the present invention inheres in a fuel collection device detachably attached a fuel cell, the fuel cell having: a power generation unit generating power by chemically reacting a fuel; a fuel flow path supplying the fuel to the power generation unit; and a circulation pump circulating the fuel in the fuel flow path, the fuel collection device including: a collection tank connected to the fuel flow path, and collecting the fuel in the fuel flow path by driving the circulation pump; an air supplier connected to the fuel flow path, and supplying an air to the power generation unit; and a recognition unit recognizing whether the fuel collection device is applicable for collecting the fuel from the fuel cell, wherein the fuel cell further comprises a control unit controlling: collecting the fuel in the fuel flow path to the collection tank by driving the circulation pump when the recognition unit recognized that the fuel collection device is applicable for collecting the fuel from the fuel cell; and supplying the air to the power generation unit by driving the supplier.

### BRIEF DESCRIPTION OF DRAWINGS

FIG. 1 is a schematic view showing an example of a fuel cell system according to a first embodiment of the present invention.

FIG. 2 is a schematic view showing an example of a fuel collection device according to the first embodiment.

FIG. 3 is a schematic view showing an example of a power generation unit according to the first embodiment.

FIG. 4 is a schematic view for explaining a normal operation of a fuel cell according to the first embodiment.

FIG. 5 is a flowchart for explaining an example of a method for collecting a fuel according to the first embodiment.

FIGS. 6 to 9 are schematic views for explaining the method for collecting the fuel according to the first embodiment.

FIG. 10 is a schematic view showing an example of a fuel cell system according to a second embodiment of the present invention.

FIG. 11 is a schematic view showing an example of a fuel collection device according to the second embodiment.

FIG. 12 is a schematic view for explaining a normal operation of a fuel cell according to the second embodiment.

FIGS. 13 to 17 are schematic views for explaining a method for collecting a fuel according to the second embodiment.

FIGS. 18 to 21 are schematic views showing examples of a fuel collection device according to other embodiments of the present invention.

FIGS. 22 to 24 are schematic views showing examples of a fuel cell system according to the other embodiments.

### DETAILED DESCRIPTION OF THE EMBODIMENT OF THE INVENTION

First and second embodiments will be described with reference to the accompanying drawings. It is to be noted that the same or similar reference numerals are applied to the same or similar parts and elements throughout the drawings, and the description of the same or similar parts and elements will be omitted or simplified.

In the following descriptions, numerous specific details are set fourth such as specific signal values, etc. to provide a thorough understanding. However, it will be obvious to those skilled in the art that the present invention may be practiced without such specific details. In other instances, well-known circuits have been shown in block diagram form in order not to obscure the present invention in unnecessary detail.

### First Embodiment

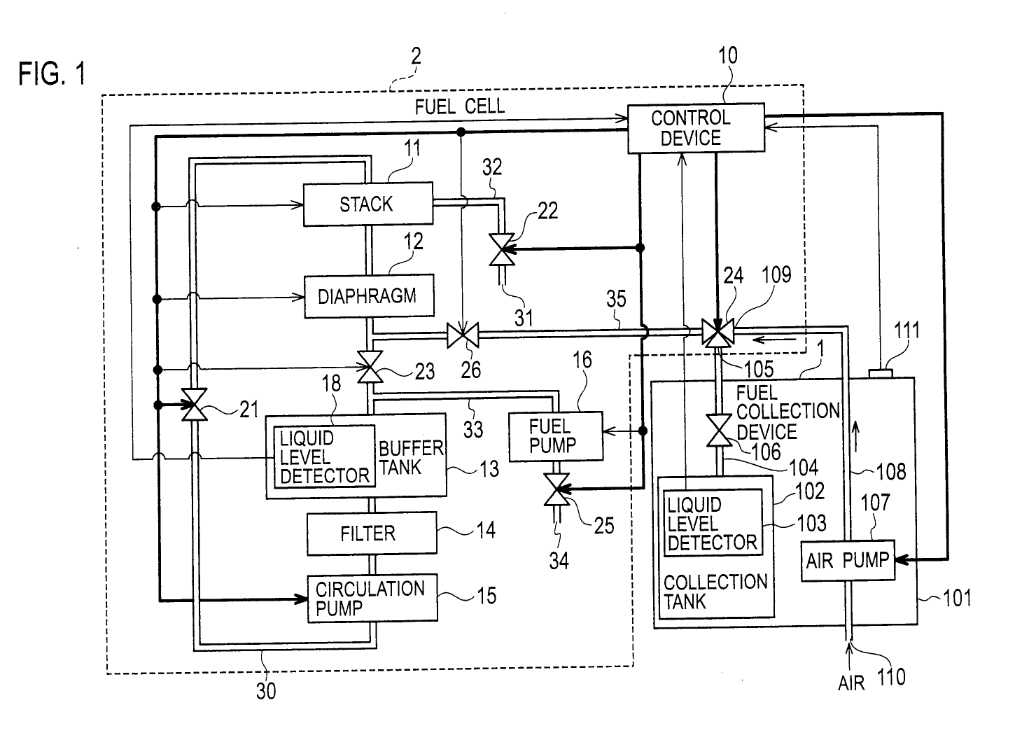

A description will be made of a fuel cell system according to a first embodiment by taking a DMFC system as an example thereof. As shown in FIG. 1, the fuel cell system according to the first embodiment includes: a fuel cell 2; and a fuel collection device (cartridge for checking fuel cell) 1 detachably attached to the fuel cell 2.

The fuel cell 2 includes: a power generation unit (stack) 11 that generates power by chemically reacting fuel; a fuel flow path 30 that supplies the fuel to the power generation unit 11; an exhaust path 32 that exhausts gas discharged from the power generation unit 11; a fuel pump 16 that supplies the fuel to the fuel flow path 30; a buffer tank 13 that stores the fuel; a circulation pump 15 that circulates the fuel in the fuel flow path 30; a switching valve 24 that is connected to the fuel flow path 30 and switches between collection of the fuel from the fuel flow path 30 and supply of air to the fuel flow path 30; and a control device 10 that controls the switching valve 24, the fuel pump 16 and the circulation pump 15.

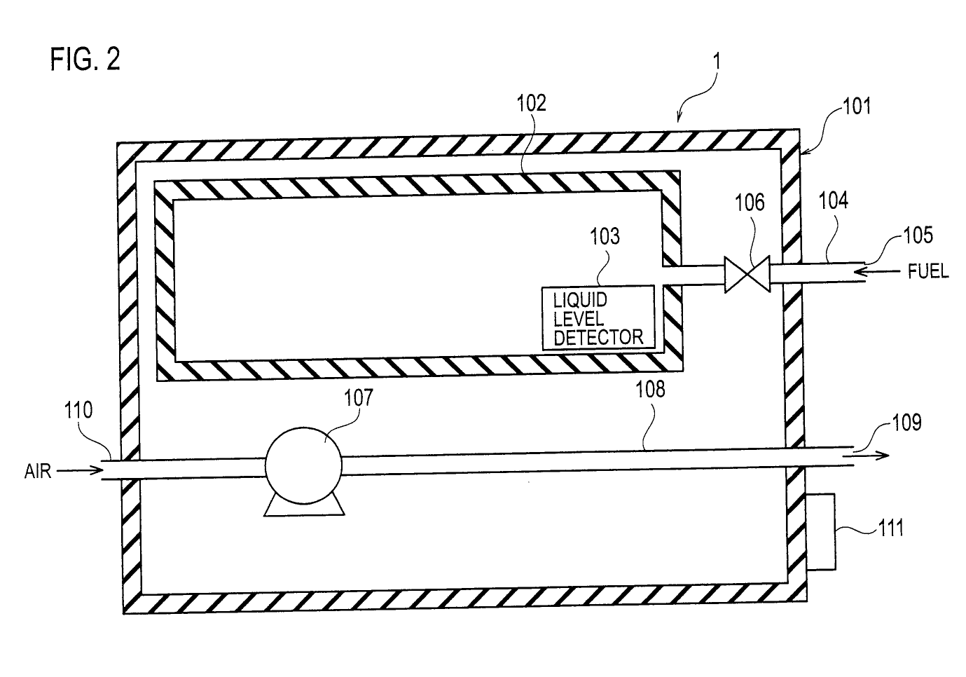

As shown in FIG. 2, the fuel collection device 1 includes: a cabinet 101; a collection tank 102 that is housed in the cabinet 101, is connected to the switching valve 24 when the fuel collection device 1 is attached to the fuel cell 2, and collects the fuel in the fuel flow path 30 through the switching valve 24 by driving the fuel pump 16 and the circulation pump 15; and an air pump (air supplier) 107 that is housed in the cabinet 101, is connected to the switching valve 24 when the fuel collection device 1 is attached to the fuel cell 2, and supplies air to the power generation unit 11 through the switching valve 24.

The cabinet 101 has a box shape in which an inside is hollow. Synthetic resin or the like is usable as a material of the cabinet 101.

The synthetic resin or the like is usable as a material of the collection tank 102. The collection tank 102 is detachable from the cabinet 101, and is replaceable with a new collection tank 102. Moreover, at least a part of the collection tank 102 may be a transparent or translucent member so that a state of the fuel collected to the collection tank 102 can be visually recognized from the outside. In this case, a display window may be provided at a position of the cabinet 101, which corresponds to the collection tank 102.

One end of a fuel collection path 104 is connected to the collection tank 102, and the other end of the fuel collection path 104 has a fuel collection port 105. A collection valve 106 is arranged in the fuel collection path 104. The collection valve 106 releases a flow of the fuel from the fuel collection port 105 to the collection tank 102, and shuts down a flow of the fuel from the collection tank 102 to the fuel collection port 105. A spring-type check valve, an electromagnetic valve or the like is usable as the collection valve 106.

A first liquid level detector 103 is attached into the collection tank 102. The first liquid level detector 103 detects a liquid level of the fuel collected into the collection tank 102.

The air pump 107 is arranged in an air supply path 108. The air supply path 108 has an air intake port 110 on one end thereof, and has an air supply port 109 on the other end thereof. The air pump 107 supplies air, which is taken in from the air intake port 110, to the fuel cell 2 through the air supply port 109.

A recognition unit 111 is attached onto the cabinet 101. A recording medium such as an IC card into which a semiconductor memory is incorporated is usable as the recognition unit 111. The recognition unit 111 stores information on the fuel collection device 1 (hereinafter, referred to as “device intrinsic information”), such as information on a capacity of the collection tank 102, on types of constituent components of the fuel collection device 1, which include a type of the air pump 107, and the like, on types of fuel cells to which the fuel collection device 1 is attachable, and on fuel collection operating procedures corresponding to plural types of the fuel cells. The recognition unit 111 allows the control device 10 of the fuel cell 2 to recognize that the fuel collection device 1 is attached to the fuel cell 2.

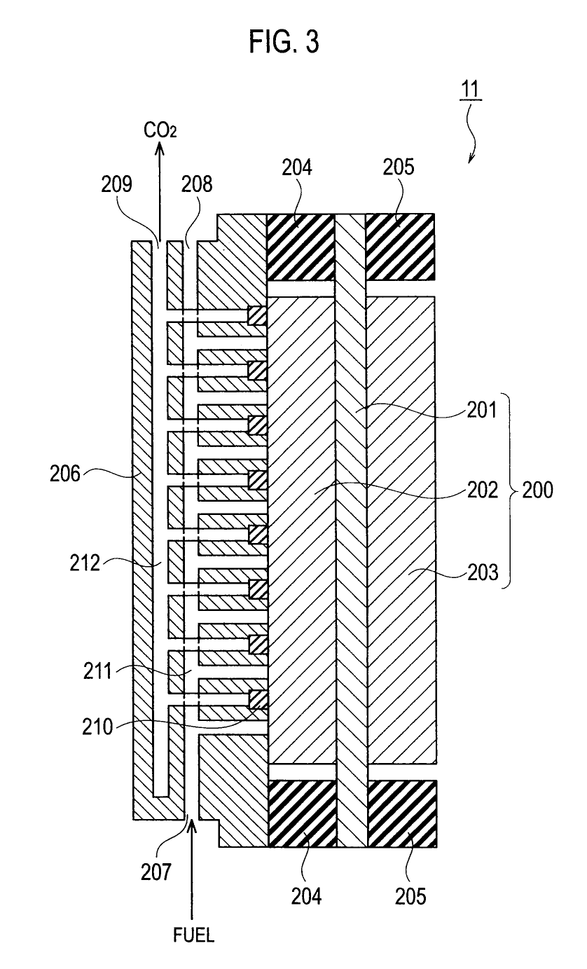

The power generation unit 11 shown in FIG. 1 generates power by chemically reacting the fuel, which is supplied thereto from the fuel flow path 30. As shown in FIG. 3, the power generation unit 11 includes: a membrane electrode assembly (MEA) 200; an anode flow path plate 206, a gas/liquid separation layer 210; an anode gasket 204; and a cathode gasket 205.

The MEA 200 includes: an electrolyte membrane 201; and an anode electrode 202 and a cathode electrode 203, which are opposite to each other while interposing the electrolyte membrane 201 therebetween. In FIG. 3, the MEA 200 is shown as a single cell for the sake of simplification. However, in actual, the power generation unit 11 composes a stack by stacking a plurality of cells on one another. As the electrolyte membrane 201, usable is a proton-conductive polymer electrolyte membrane such as that of a copolymer of tetrafluoroethylene (TFE) and perfluorovinyl ether sulfonic acid, for example, Nafion (trademark) membrane. A catalyst such as platinum-ruthenium (PtRu) is usable as the anode electrode 202. A catalyst such as platinum (Pt) is usable as the cathode electrode 203.

A conductive material such as carbon or metal is usable as a material of the anode flow path plate 206. The anode flow path plate 206 includes: a fuel flow path 211 having a fuel inlet 207 and a fuel outlet 208; and a gas flow path 212 having a gas outlet 209. The fuel flow path 211 supplies the fuel, which is introduced thereinto from the fuel inlet 207, to the anode electrode 202, and discharges water generated by the reaction and unreacted fuel from the fuel outlet 208. The gas flow path 212 discharges carbon dioxide (CO₂) , which is generated by the reaction, from the gas outlet 209.

The gas/liquid separation layer 210 is arranged between the gas flow path 212 and the anode electrode 202. The gas/liquid separation layer 210 separates, into gas and liquid, a two-phase flow containing CO₂ generated in the anode electrode 202 and the unreacted fuel, guides CO₂ to the gas flow path 212, and guides the unreacted fuel to the fuel flow path 211. As a material of the gas/liquid separation layer 210, usable is a porous layer made of carbon paper, carbon cloth, carbon nonwoven fabric or the like having conductivity, hydrophobicity (water repellency) and gas permeability.

The anode gasket 204 and the cathode gasket 205 are arranged so as to surround the anode electrode 202 and the cathode electrode 203 therein. The anode gasket 204 and the cathode gasket 205 prevent fuel or air leakage to the exterior. An insulating material such as polyphenyl sulfide (PPS) and polyethylene terephthalate (PET) is usable as a material of the anode gasket 204 and the cathode gasket 205.

The respective reactions in the anode electrode 202 and cathode electrode 203 of the power generation unit 11 are represented by chemical formulas (1) and (2).

CH₃OH +H₂O →CO₂+6H⁺+6e⁻. . . (1)

O₂+4H⁺+4e⁻→2H₂O . . . (2)

Protons (H⁺) generated by the reaction in the anode electrode 202 permeate the electrolyte membrane 201 and move to the cathode electrode 203. Electrons generated by the reaction in the anode electrode 202 move to the cathode electrode 203 via an external circuit (not shown). CO₂ generated by the reaction in the anode electrode 202 is discharged from the gas outlet 209 through the gas/liquid separation layer 210. A part of the water unreacted in the anode electrode 202 is mixed with an aqueous methanol solution in the fuel flow path 211, and is discharged from the fuel outlet 208. The rest of the unreacted water permeates the electrolyte membrane 201, and is discharged to the outside from the cathode side. A part of the water generated by the reaction in the cathode electrode 203 is inversely diffused to the anode electrode 202 side through the electrode membrane 201, and the rest thereof is discharged to the outside from the cathode electrode 203.

The fuel inlet 207 and the fuel outlet 208 are connected to the fuel flow path 30 shown in FIG. 1. The gas outlet 209 is connected to the exhaust path 32 having an exhaust port 31. An exhaust valve 22 is arranged in the exhaust path 32.

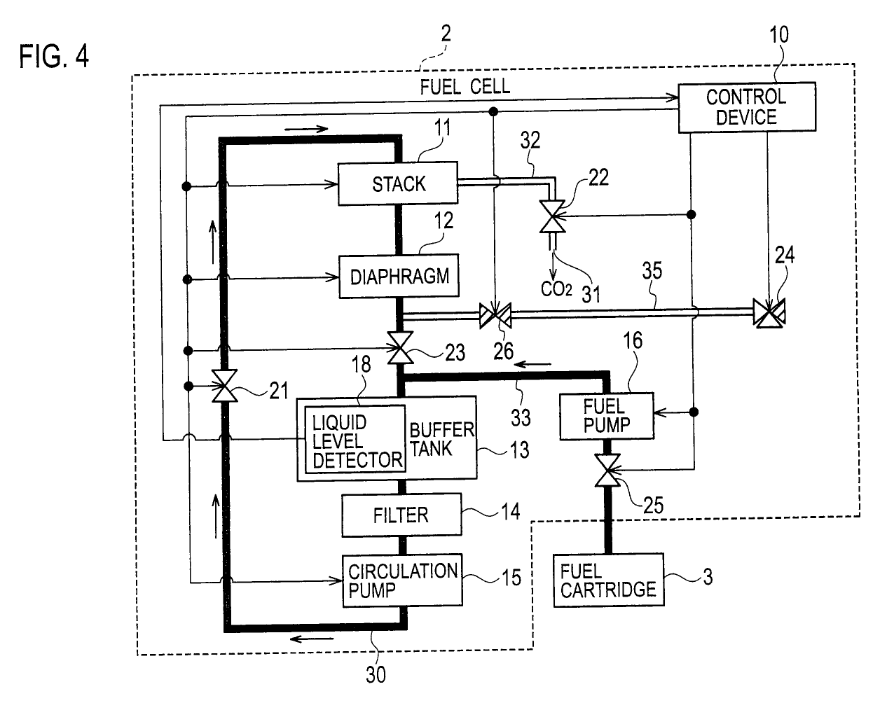

The fuel pump 16 is connected to a fuel supply path 33 branched from the fuel flow path 30. As shown in FIG. 4, the fuel pump 16 is connected to a fuel cartridge 3 through a fuel supply valve 25. The fuel cartridge 3 is detachable from the fuel cell 2, and holds the fuel to be supplied to the fuel cell 2. The fuel pump 16 supplies the fuel, which is supplied from the fuel cartridge 3, to the fuel flow path 30. The fuel pump 16 is electrically connected to the control device 10. The number of revolutions and the like of the fuel pump 16 are controlled by the control device 10, and the fuel pump 16 adjusts a flow rate of the fuel in the fuel flow path 33.

The buffer tank 13 mixes, with water, the fuel and the water, which are returned from the fuel outlet 208 of the power generation unit 11 through the fuel flow path 30, and the fuel supplied through the fuel pump 16, and stores an aqueous methanol solution that is thus obtained and is diluted into a predetermined concentration (for example, 3 to 6 mass %) for allowing high power generation efficiency. A second liquid level detector 18 is attached to the buffer tank 13. The second liquid level detector 18 is electrically connected to the control device 10. The second liquid level detector 18 detects a liquid level of the aqueous methanol solution in the buffer tank 13.

The circulation pump 15 supplies the fuel, which is stored in the buffer tank 13, through the fuel flow path 30 to the fuel inlet 207 of the power generation unit 11. The circulation pump 15 is electrically connected to the control device 10. The number of revolutions and the like of the circulation pump 15 are controlled by the control device 10, and the circulation pump 15 adjusts a flow rate of the fuel in the fuel flow path 30. The circulation pump 15 has a forward driving mode and a reverse driving mode.

A filter 14 is arranged between the buffer tank 13 and the circulation pump 15. The filter 14 removes dust and impurities in the fuel . A diaphragm 12 is arranged between the power generation unit 11 and the buffer tank 13. The diaphragm 12 constricts the fuel flow path 30, and adjusts a pressure of the fuel. The diaphragm 12 is electrically connected to the control device 10, and is controlled by the control device 10. A circulation valve 23 is arranged in the fuel flow path 30 between the diaphragm 12 and the buffer tank 13. A branch flow path 35 is branched between the circulation valve 23 and the diaphragm 12. The switching valve (three-way valve) 24 is connected to the branch flow path 35 through an air supply valve 26. A circulation valve 21 is arranged between the circulation pump 15 and the power generation unit 11. Each of the circulation valves 21 and 23, the exhaust valve 22, the switching valve 24, the fuel supply valve 25 and the air supply valve 26 is electrically connected to the control device 10, and opening and closing thereof are controlled by the control device 10.

A central processing unit (CPU) is usable as the control device 10. When the recognition unit 111 is electrically connected to the control device 10, the control device 10 recognizes that the fuel collection device 1 is attached to the fuel cell 2. The control device 10 acquires the device intrinsic information stored in the recognition unit 111. Based on the device intrinsic information, the control device 10 determines (recognizes) whether or not the fuel collection device 1 is applicable for collecting the fuel from the fuel cell 2. Moreover, in the case of having determined that the fuel collection device 1 is applicable, the control device 10 controls actions of the respective constituent components in accordance with a fuel collection operating procedure corresponding to the fuel cell 2, to which the fuel collection device 1 is attached, among the fuel collection operating procedures corresponding to the plural types of fuel cells. Then, the control device 10 implements a fuel collection operation.

At the time of a normal operation of the fuel cell 2 according to the first embodiment, as shown in FIG. 4, the fuel cartridge 3 is attached to the fuel cell 2, and the fuel supply path 33 of the fuel cartridge 3 is connected to the fuel supply valve 25. In a state where the air supply valve 26 is closed and the circulation valves 21 and 23, the exhaust valve 22 and the fuel supply valve 25 are opened, the fuel pump 16 is driven, whereby the fuel held in the fuel cartridge 3 is supplied to the fuel flow path 30 through the fuel supply path 33. In addition, the circulation pump 15 is driven, whereby the fuel in the fuel flow path 30 is circulated, and is supplied to the power generation unit 11. The power generation unit 11 generates power by the chemical reaction, and supplies the power to an electronic instrument (not shown). In the event of stopping the normal operation, the drive of the fuel pump 16 and the circulation pump 15 is stopped. The fuel cartridge 3 can be detached from the fuel cell 2 after closing the fuel supply valve 25.

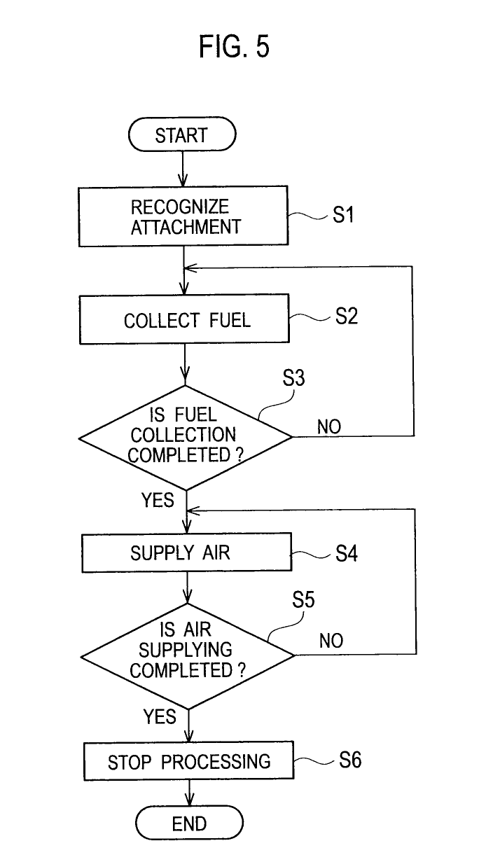

Next, a description will be made of an example of a fuel collection method using the fuel cell system according to the first embodiment while referring to a flowchart of FIG. 5.

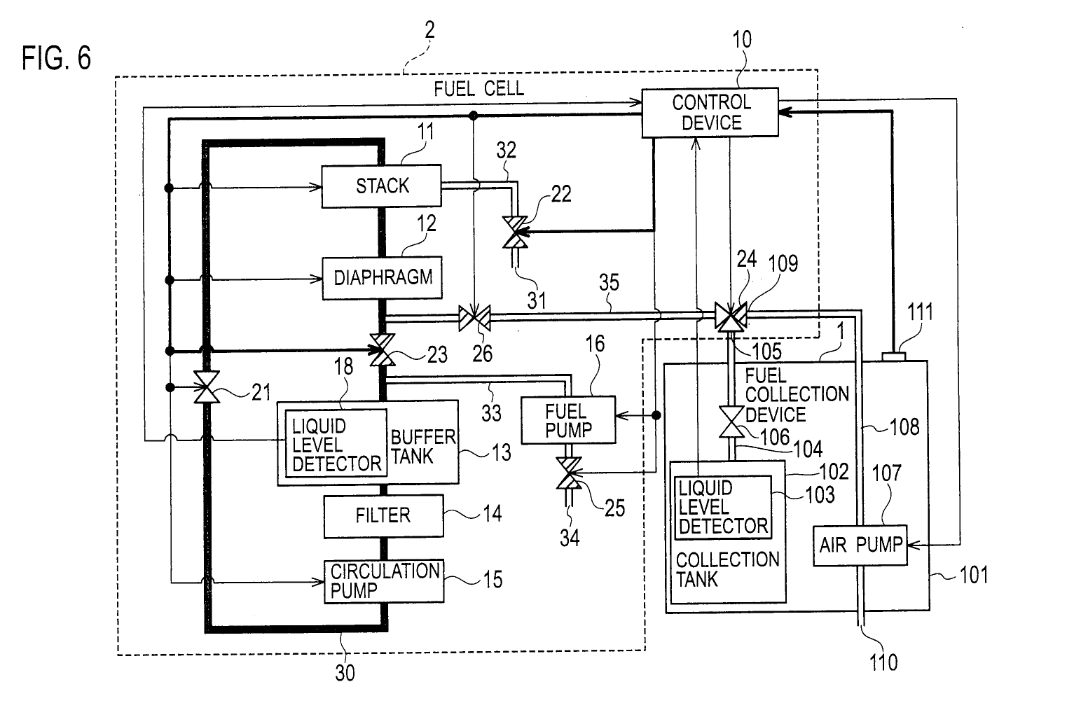

In Step S1, in a state where the fuel supply valve 25 is closed and the fuel cartridge 3 is detached from the fuel cell 2 after the normal operation shown in FIG. 4, the fuel collection device 1 is attached to the fuel cell 2 as shown in FIG. 6. At this time, each of the fuel collection port 105 and air supply port 109 of the fuel collection device 1 is connected to the switching valve 24. Moreover, the recognition unit 111, the air pump 107 and the first liquid level detector 103 are electrically connected to the control device 10. When the control device 10 recognizes that the fuel collection device 1 is attached to the fuel cell 2, the control device 10 closes the circulation valve 23 and the exhaust valve 22.

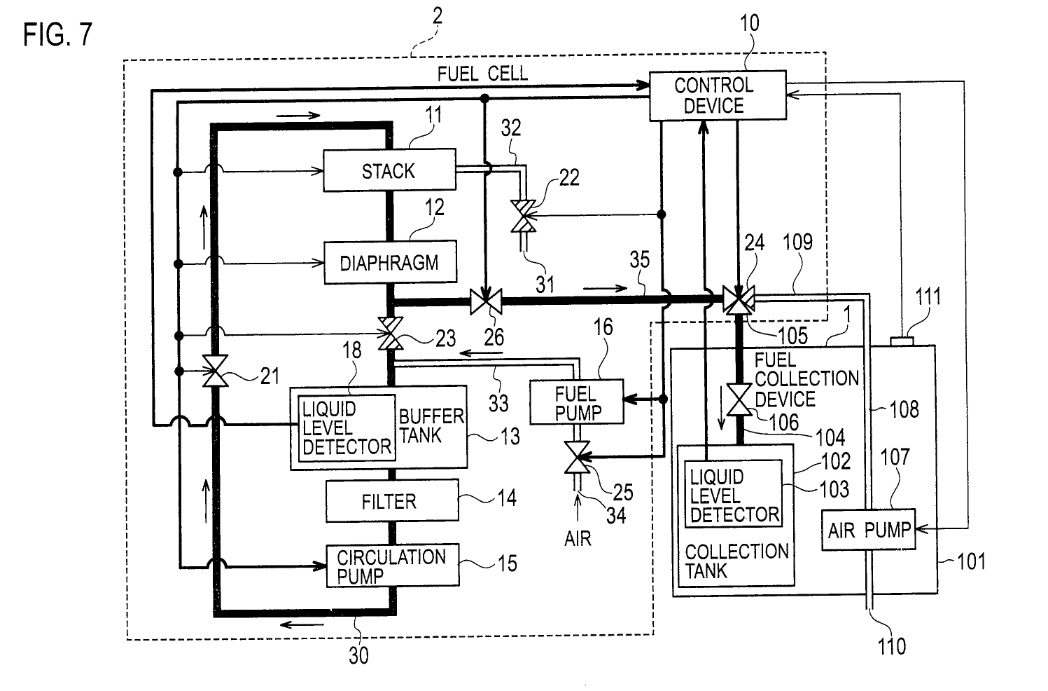

In Step S2, the fuel collection device 1 collects the fuel, which is held in the fuel cell 2, to the collection tank 102. First, as shown in FIG. 7, the air supply valve 26 and the fuel supply valve 25 are opened. The switching valve 24 is switched so that the branch flow path 35 and the fuel collection path 104 can communicate with each other. The circulation pump 15 is driven in this state, whereby the air is taken in from a fuel supply port 34. In addition, the fuel held in the fuel flow path 30 is collected to the collection tank 102. The control device 10 determines whether or not the liquid level detected by the second liquid level detector 18 is zero, or whether or not the liquid level concerned is a predetermined threshold value or less. This predetermined threshold value may be stored, for example, in the recognition unit 111 in advance. In the case of having determined that the liquid level detected by the second liquid level detector 18 is zero, or is the predetermined threshold value or less, the control device 10 drives the circulation pump 15 and the fuel pump 16. In such a way, the air is further taken in from the fuel supply port 34. In addition, the remaining fuel held in the fuel flow path 30 is collected to the collection tank 102. Note that, even in the case where it has not been determined that the liquid level detected by the second liquid level detector 18 is zero, or is the predetermined threshold value or less, the drive of the fuel pump 16 may be started also in the case where a predetermined period has elapsed since the drive of the circulation pump 15 was started. Moreover, the drive of the fuel pump 16 may be started simultaneously with the start of the drive of the circulation pump 15 without depending on the liquid level detected by the second liquid level detector 18.

In Step S3, the control device 10 determines whether or not to finish collecting the fuel held in the fuel cell 2. For example, in the case where the liquid level detected by the first liquid level detector 103 has exceeded a predetermined threshold value, the control device 10 determines to finish collecting the fuel. This predetermined threshold value may be stored, for example, in the recognition unit 111 in advance. Note that, also in the case where a predetermined period has elapsed since the drive of the fuel pump 16 was started while the liquid level detected by the first liquid level detector 103 was kept from exceeding the predetermined threshold value, the control device 10 may determine to finish collecting the fuel.

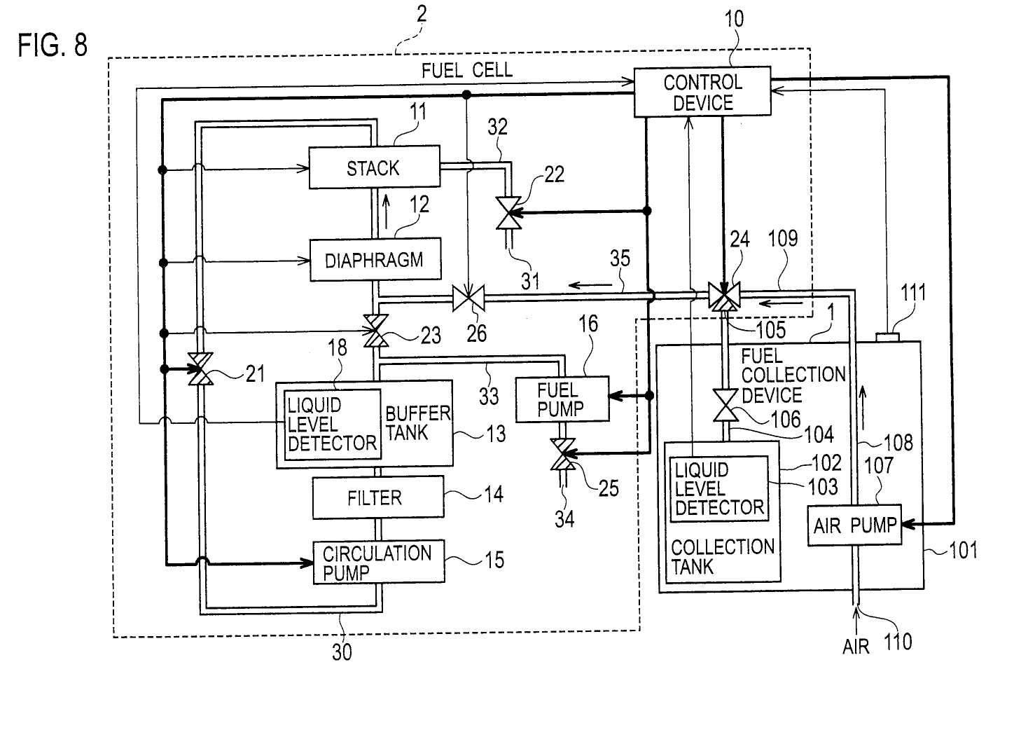

In Step S4, the power generation unit 11 is dried by being supplied with the air. First, as shown in FIG. 8, the circulation pump 15 and the fuel pump 16 are stopped, the fuel supply valve 25 and the circulation valve 21 are closed, and the exhaust valve 22 is opened. The switching valve 24 is switched so that the branch flow path 35 and the air supply path 108 can communicate with each other. The air pump 107 is driven in this state, whereby the air taken in from the air intake port 110 is supplied to the power generation unit 11, and is exhausted from the exhaust port 31. The power generation unit 11 is dried as described above, whereby an effect is brought in that a voltage in the stack is decreased. Moreover, there are advantages in that an electric shock at the time when a user handles the stack is prevented, and in addition, that the user can be prevented from getting burned by reaction heat generated by an oxidation reaction of the fuel and the oxygen in the stack, which is caused by the catalyst.

In Step S5, the control device 10 determines whether or not to finish supplying the air to the power generation unit 11. For example, a thermometer (not shown) that measures a temperature of the power generation unit 11 is provided in the fuel cell 2 in advance. Based on information obtained from this thermometer, the control device 10 determines to finish supplying the air in the case where the temperature of the power generation unit 11 drops down to a predetermined threshold value or lower. Alternatively, the control device 10 determines to finish supplying the air in the case where a predetermined period has elapsed since the drive of the air pump 107 was started. The above-described predetermined threshold value may be stored, for example, in the recognition unit 111 in advance. If the power generation unit 11 is dried insufficiently, and the fuel remains in the stack, then in some case, the temperature of the stack becomes high since the fuel and the oxygen cause the oxidation reaction by the catalyst to thereby generate the reaction heat. In such a way, the control device 10 can determine whether or not the power generation unit 11 is dried based on whether or not the temperature thereof drops down to the predetermined threshold value or lower.

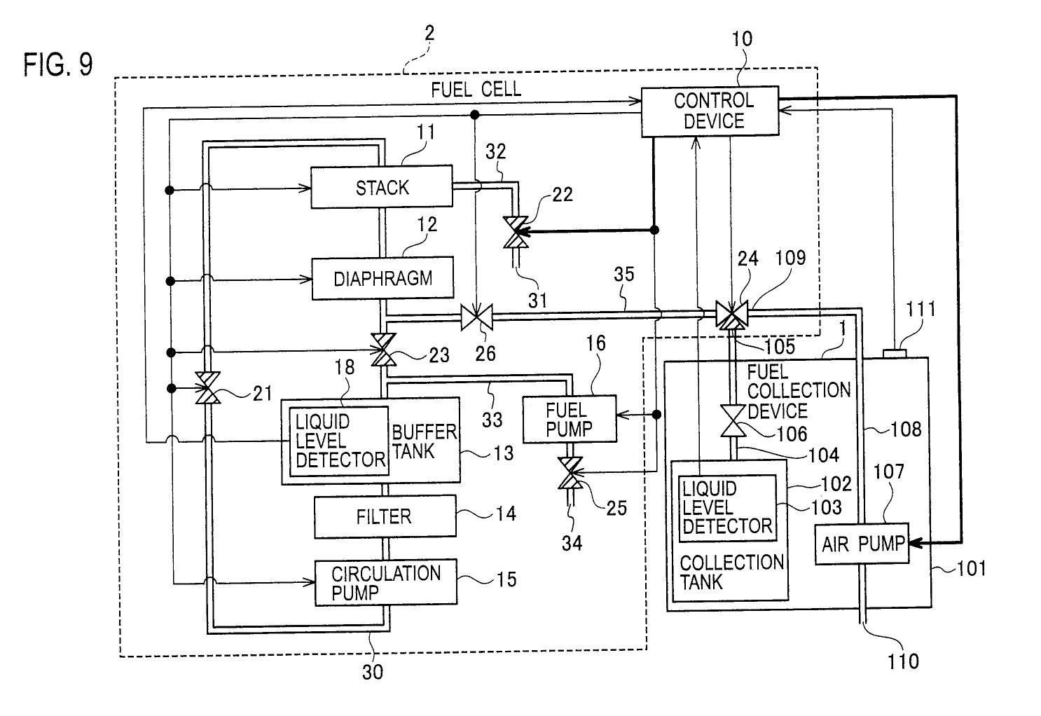

In Step S6, as shown in FIG. 9, the air pump 107 is stopped, and the exhaust valve 22 is closed.

As described above, in accordance with the fuel collection device 1 according to the first embodiment, an amount of the fuel remaining in the fuel cell 2 can be decreased to a large extent as compared with the conventional one. Hence, the user who uses the fuel cell 2 or a checker who checks the fuel cell 2 can safely perform the check and disposal for the fuel cell 2, and an operation to store the fuel cell 2 for a long period.

### Second Embodiment

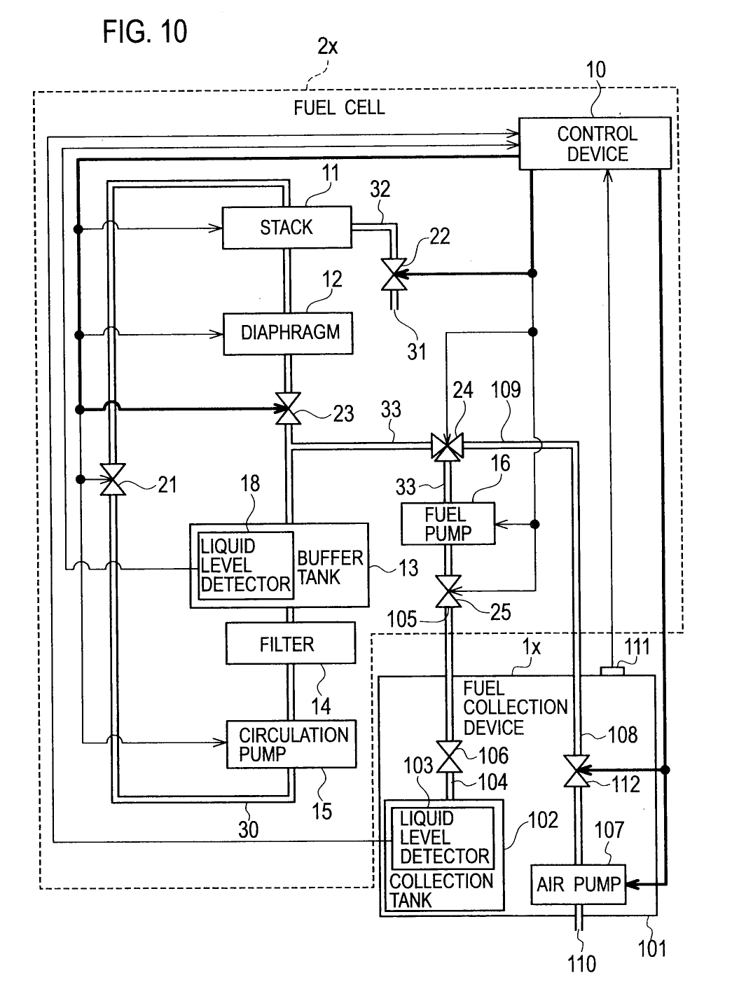

As shown in FIG. 10, a fuel cell system according to a second embodiment includes: a fuel cell 2x; and a fuel collection device 1x detachably attached to the fuel cell 2x.

The fuel cell 2x is different from the fuel cell 2 shown in FIG. 1 in that the switching valve 24 is arranged between the fuel supply path 33 and the fuel pump 16, and that the branch flow path 35 that is shown in FIG. 1 and connected to the switching valve 24 is omitted. Other configurations of the fuel cell 2x are substantially similar to configurations of the fuel cell 2 shown in FIG. 1. Accordingly, a duplicate description will be omitted.

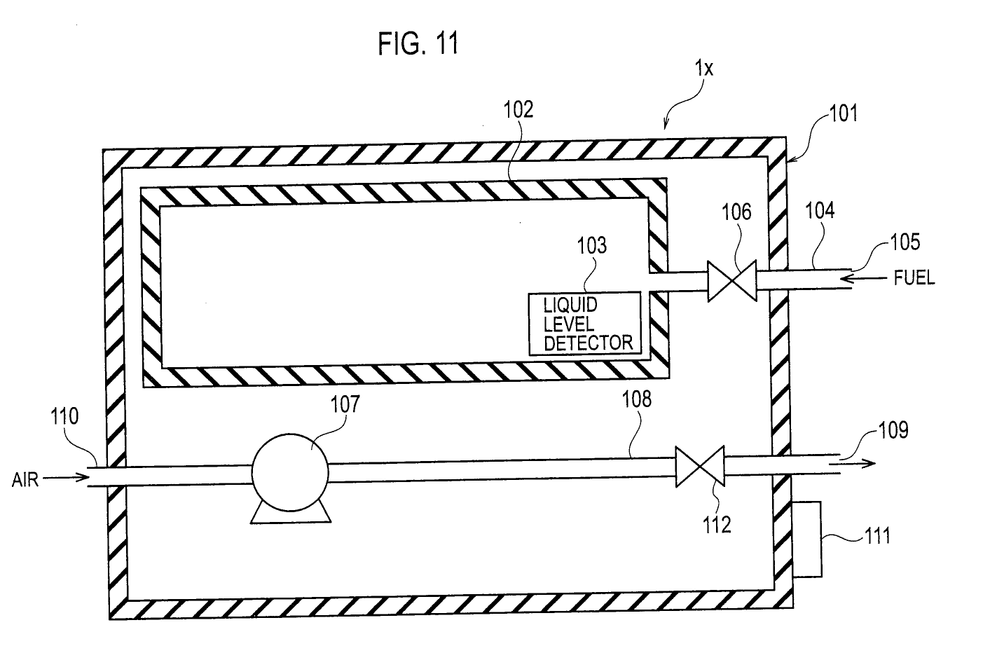

As shown in FIG. 11, the fuel collection device 1x is different from the fuel collection device 1 shown in FIG. 2 in further including an air supply valve 112 in the air supply path 108. Other configurations of the fuel collection device 1x are substantially similar to configurations of the fuel collection device 1 shown in FIG. 2. Accordingly, a duplicate description will be omitted.

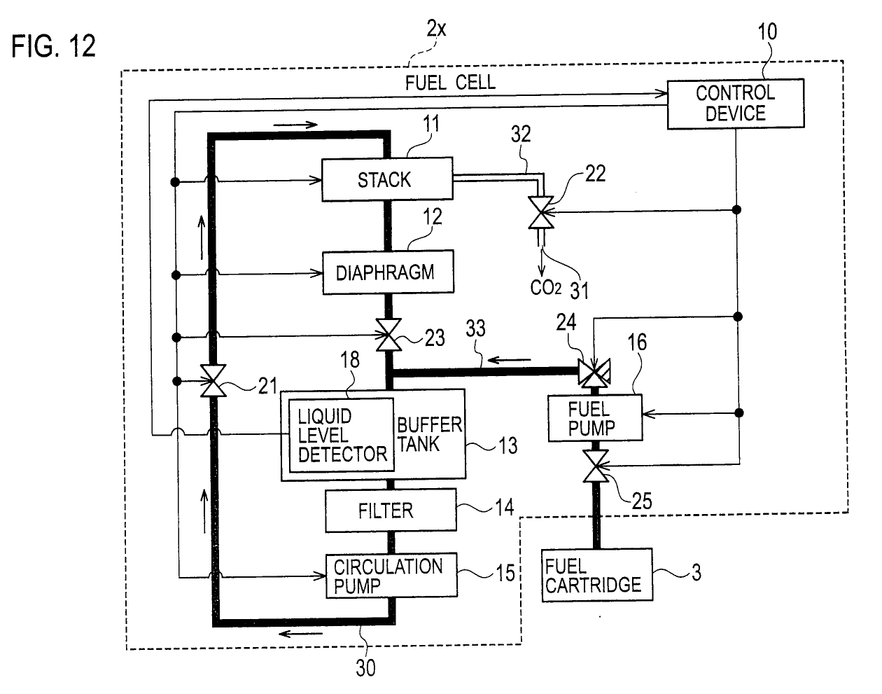

At the time of a normal operation of the fuel cell 2x according to the second embodiment, as shown in FIG. 12, the fuel cartridge 3 is attached to the fuel cell 2x, and a fuel supply port of the fuel cartridge 3 is connected to the fuel supply valve 25. Then, the fuel supply valve 25, the circulation valves 21 and 23 and the exhaust valve 22 are opened, and the switching valve 24 is switched so that the fuel pump 16 and the fuel supply path 33 can communicate with each other. The fuel pump 16 is driven in this state, whereby the fuel held in the fuel cartridge 3 is supplied to the fuel flow path 30 through the fuel supply path 33. Moreover, the circulation pump 15 is driven, whereby the fuel in the fuel flow path 30 is circulated, and is supplied to the power generation unit 11. The power generation unit 11 generates the power by the chemical reaction, and supplies the power to the electronic instrument (not shown). In the event of stopping the normal operation, the drive of the fuel pump 16 and the circulation pump 15 is stopped. The fuel cartridge 3 can be detached from the fuel cell 2x after closing the fuel supply valve 25.

Next, a description will be made of an example of a fuel collection method of the fuel cell system according to the second embodiment of while referring to the flowchart of FIG. 5.

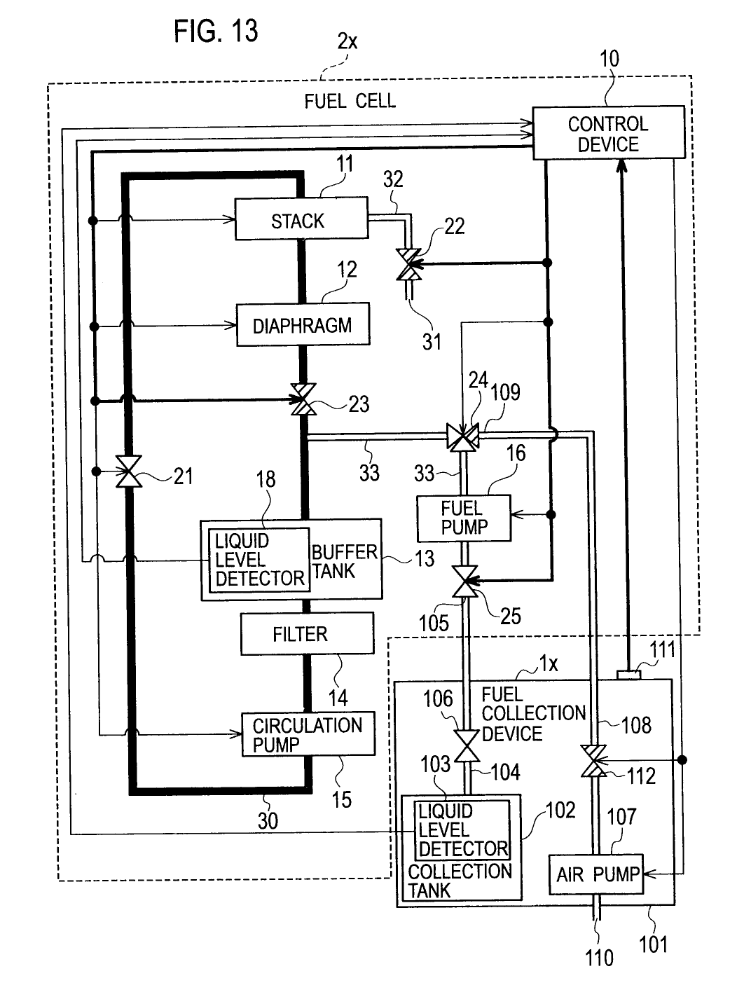

In Step S1, in a state where the fuel supply valve 25 is closed and the fuel cartridge 3 is detached from the fuel cell 2x after the normal operation shown in FIG. 12, the fuel collection device 1x is attached to the fuel cell 2x as shown in FIG. 13. At this time, the fuel collection port 105 of the fuel collection device 1x is connected to the fuel supply valve 25 to which the fuel cartridge 3 was connected. The air supply port 109 is connected to the switching valve 24. The recognition unit 111, the air pump 107 and the first liquid level detector 103 are electrically connected to the control device 10. When the control device 10 recognizes that the fuel collection device lx is attached to the fuel cell 2x in such a manner that the recognition unit 111 is electrically connected to the control device 10, the control device 10 opens the fuel supply valve 25, and closes the circulation valve 23 and the exhaust valve 22.

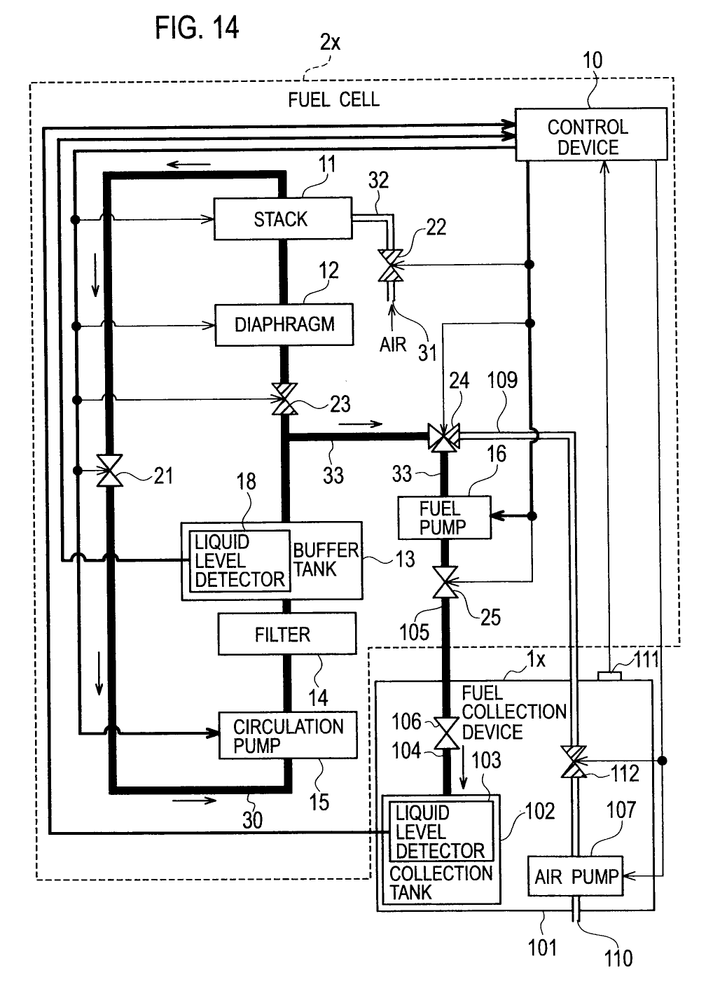

In Step S2, as shown in FIG. 14, each of the fuel pump 16 and the circulation pump 15 is reversely driven, whereby the fuel held in the fuel flow path 30 is collected to the collection tank 102.

In Step S3, the control device 10 determines whether or not to finish collecting the fuel held in the fuel cell 2x. For example, in the case where the liquid level detected by the first liquid level detector 103 has exceeded the predetermined threshold value, the control device 10 determines to finish collecting the fuel. Note that, also in the case where a predetermined period has elapsed since the drive of the fuel pump 16 was started while the liquid level detected by the first liquid level detector 103 was kept from exceeding the predetermined threshold value, the control device 10 may determine to finish collecting the fuel. Moreover, the control device 10 may determine to finish collecting the fuel in the case where the liquid level detected by the second liquid level detector 18 becomes zero or the predetermined threshold value or less. In this case, the control device 10 may determine to finish collecting the fuel in the case where a predetermined period has elapsed since the drive of the circulation pump 15 was started even in the case where the liquid level detected by the second liquid level detector 18 does not become zero or the predetermined threshold value or less.

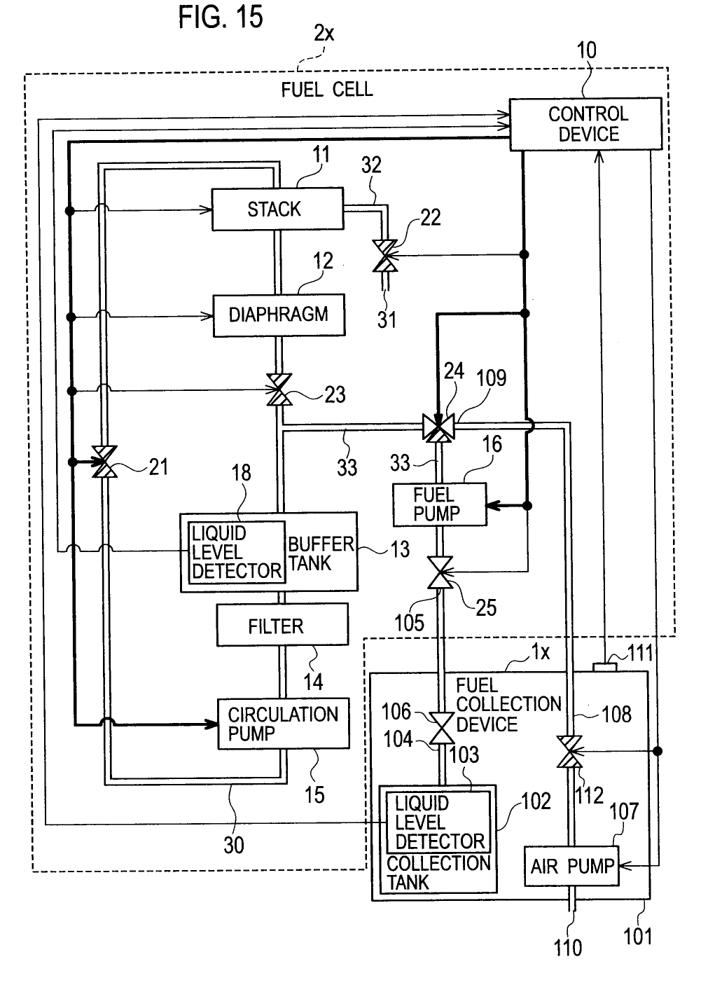

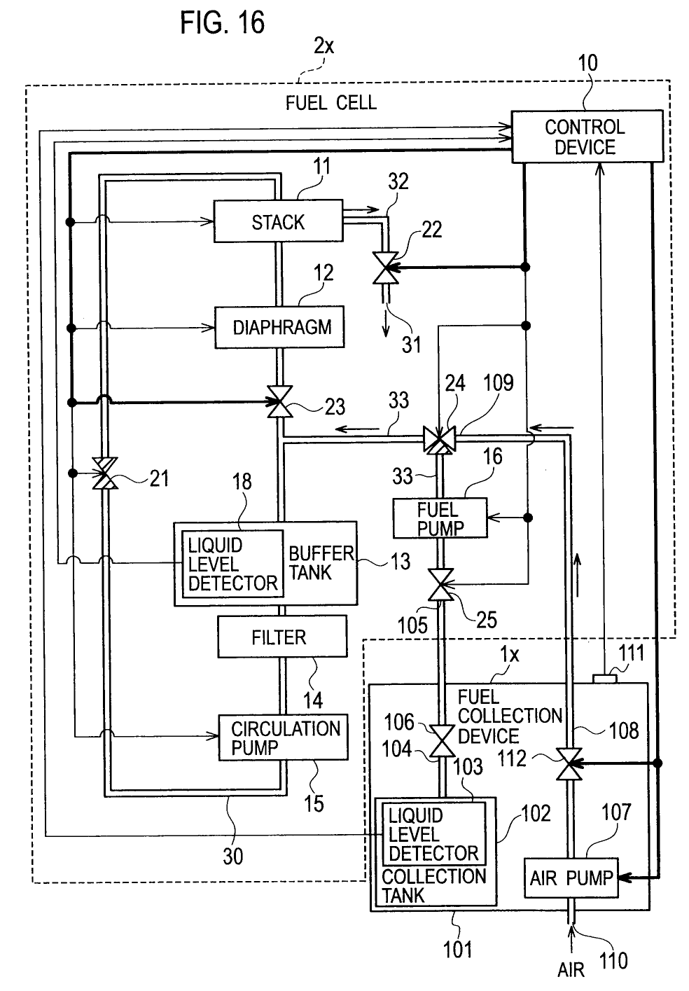

In Step S4, the power generation unit 11 is dried by being supplied with the air. First, as shown in FIG. 15, the circulation valve 21 is closed, and the circulation pump 15 and the fuel pump 16 are sequentially stopped. The switching valve 24 is switched so that the fuel supply path 33 and the air supply port 109 can communicate with each other. Next, as shown in FIG. 16, the circulation valve 23 and the air supply valve 112 are opened, and the air pump 107 is driven. The air is taken in from the air intake port 110, and the air thus taken in is supplied to the power generation unit 11, and is exhausted from the exhaust port 31.

In Step S5, the control device 10 determines whether or not to finish supplying the air to the power generation unit 11. For example, the control device 10 determines whether or not to finish supplying the air based on whether or not the temperature of the power generation unit 11 becomes the predetermined threshold value or lower, or based on whether or not a predetermined period has elapsed since the drive of the air pump 107 was started.

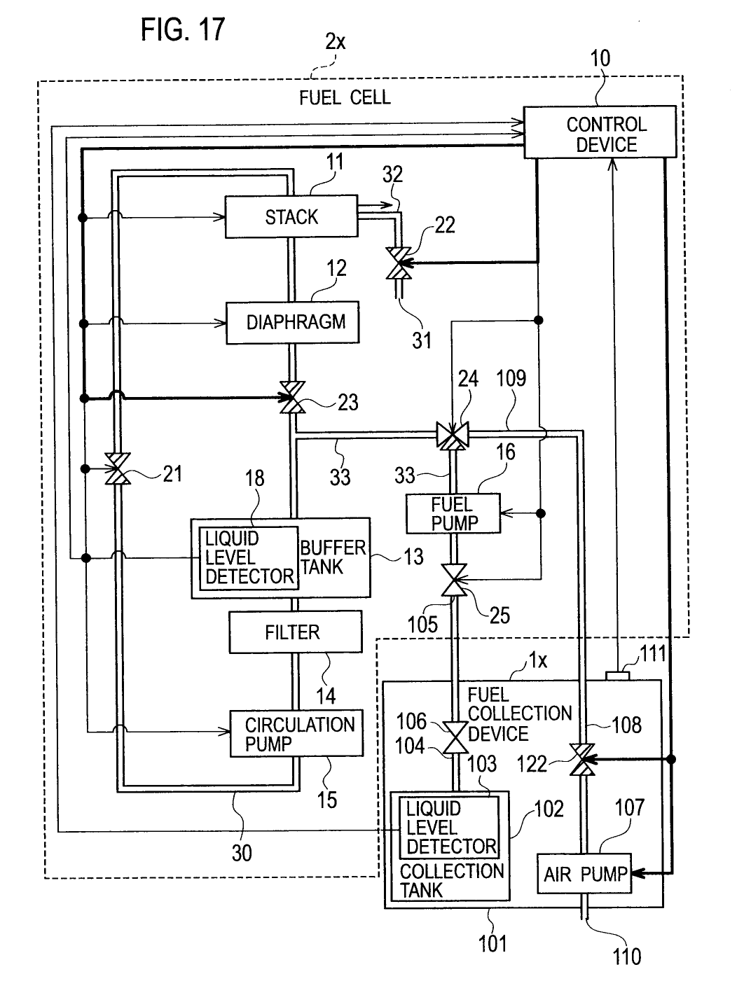

In Step S6, as shown in FIG. 17, the air pump 107 is stopped, and each of the air supply valve 112, the circulation valve 23 and the exhaust valve 22 is closed.

As described above, in accordance with the fuel collection device 1x according to the second embodiment, an amount of the fuel remaining in the fuel cell 2x can be decreased to a large extent as compared with the conventional one. Hence, a user who uses the fuel cell 2x or a checker who checks the fuel cell 2x can safely perform check and disposal for the fuel cell 2x, and an operation to store the fuel cell 2x for a long period.

### Other Embodiments

Various modifications will become possible for those skilled in the art after receiving the teachings of the present disclosure without departing from the scope thereof.

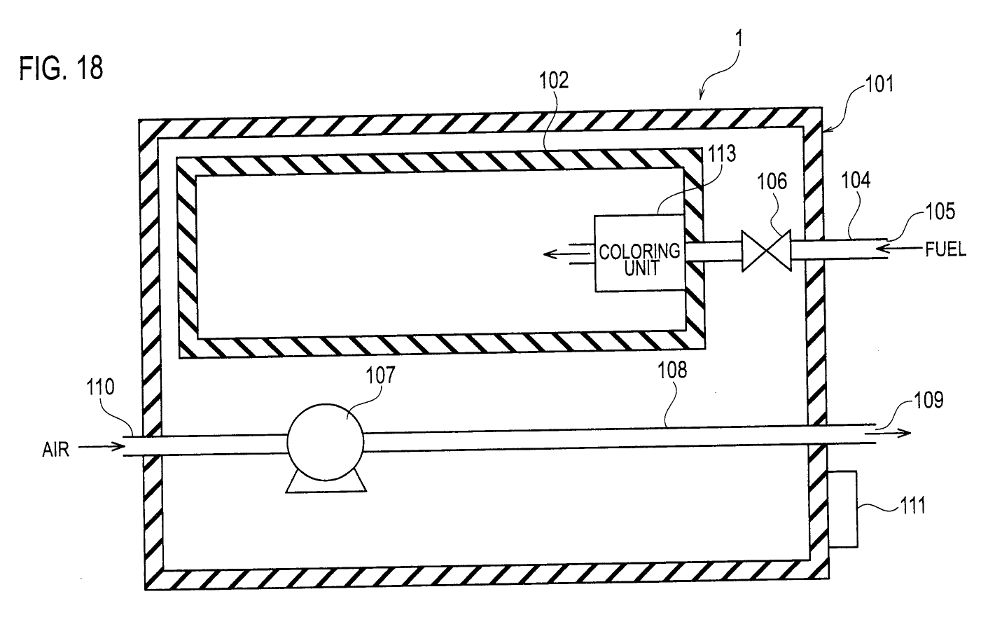

For example, as shown in FIG. 18, the fuel collection device 1 may further include a coloring unit 113 provided in the collection tank 102. The coloring unit 113 is filled with pigment or dye, which colors the fuel collected to the collection tank 102. In such a way, visual conspicuousness of the collected fuel can be enhanced. Note that the coloring unit 113 may be provided in the fuel collection path 104. The fuel remaining in the flow path is converted into a form by which the fuel is easy to collect, whereby the user and the checker can safely perform the operations.

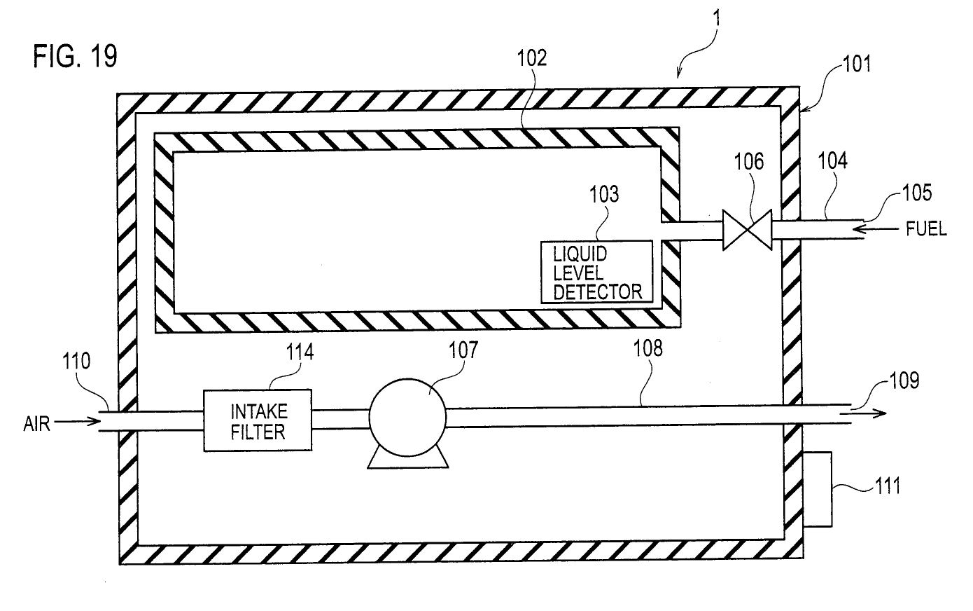

As shown in FIG. 19, the fuel collection device 1 may further include an intake filter 114 detachably attached to the air supply path 108. Impurities contained in the air can be removed by the intake filter 114.

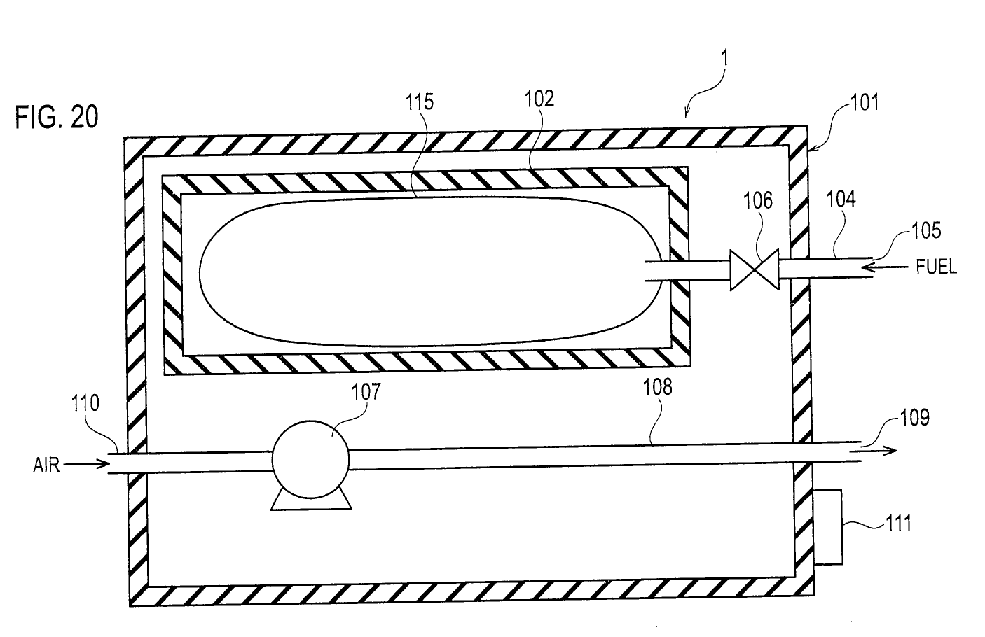

As shown in FIG. 20, the fuel collection device 1 may further include a fuel holding pack 115 housed in the collection tank 102. The fuel holding pack 115 has stretchability and flexibility, and is deformable by the liquid level of the fuel collected thereinto. As a material of the fuel holding pack 115, any of the following is usable, which are: any one material among polycarbonate (PC), polyamide (PA) including Nylon 6, polypropylene (PP), polyester including polyethylene terephthalate (PET), polyacetal (POM), polyethylene (PE), polyvinyl chloride (PVC), polytetrafluoroethylene (PTFE), ethylene-tetrafluoroethylene copolymer (ETFE), polymethylpentene (TPX), ethylene-vinyl acetate copolymer (EVA), polyurethane (PU), polyetherimide (PEI), polyphenylene sulfide (PPS), and ultra high molecular weight polyethylene (UHMWPE); or a copolymer composed of two or more materials selected from these materials; or a synthesis composed of two or more materials selected from these materials; or fiber reinforced plastics (FRP) including glass fiber reinforced polyester; or a resin laminate including a polyethylene laminate and a polypropylene laminate. The form by which the fuel remaining in the flow path is easy to collect is adopted, whereby the user and the checker can safely perform the operations. Note that the collection tank 102 itself may be composed of the material of the fuel holding pack 115, and may have a function of the fuel holding pack 115.

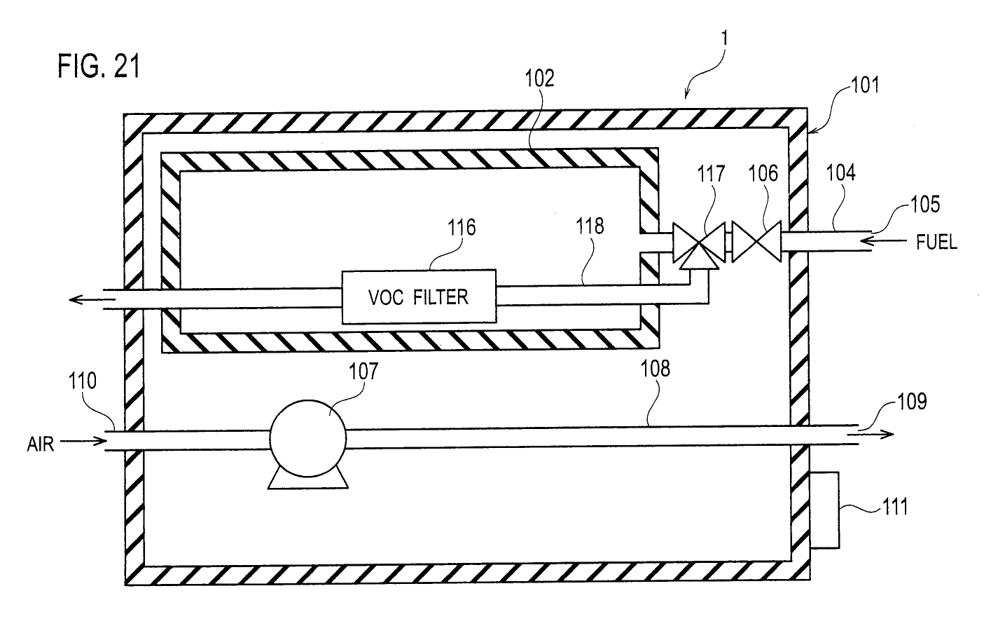

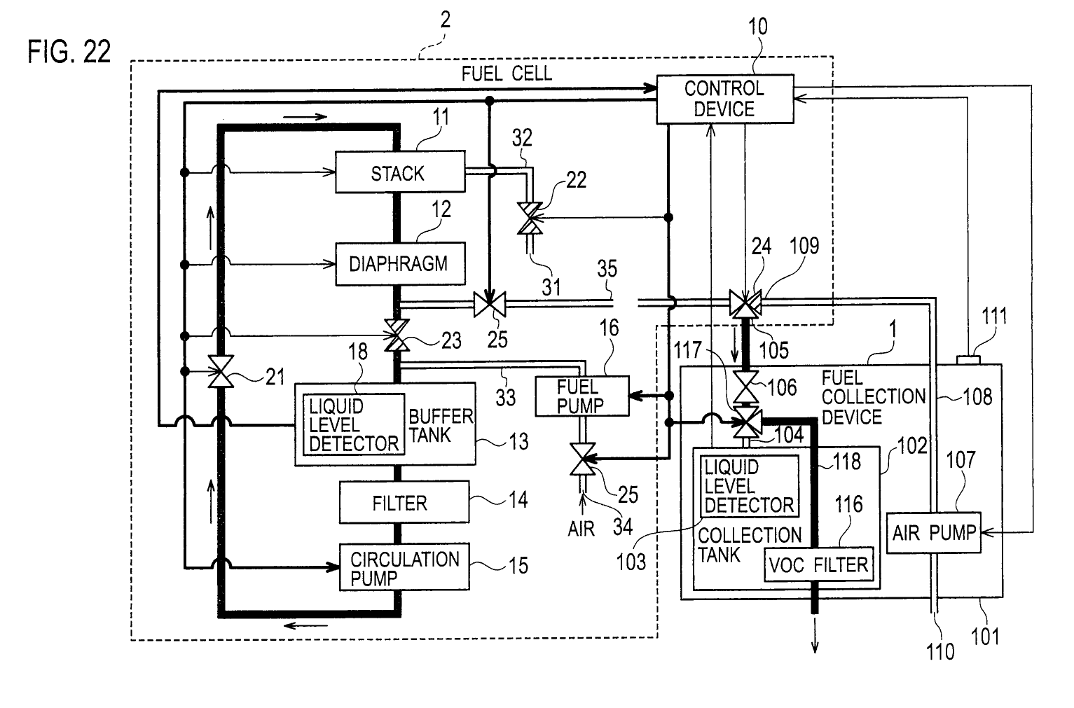

As shown in FIG. 21, the fuel collection device 1 may include a switching valve 117 arranged in the fuel collection path 104, and a harmful substance removal filter (volatile organic compound (VOC) removal filter) 116 detachably arranged in an auxiliary collection path 118. As shown in FIG. 22, the switching valve 117 is electrically connected to the control device 10. In the event of collecting the fuel, the switching valve 117 is switched so that the branch flow path 35 and the auxiliary collection path 118 can communicate with each other. Harmful substances such as a volatile organic compound (VOC) in the collected fuel are removed by the harmful substance removal filter 116, and the form by which the fuel is easy to collect is adopted, whereby the fuel can be fully used effectively, and diffusion of the harmful substances can be prevented.

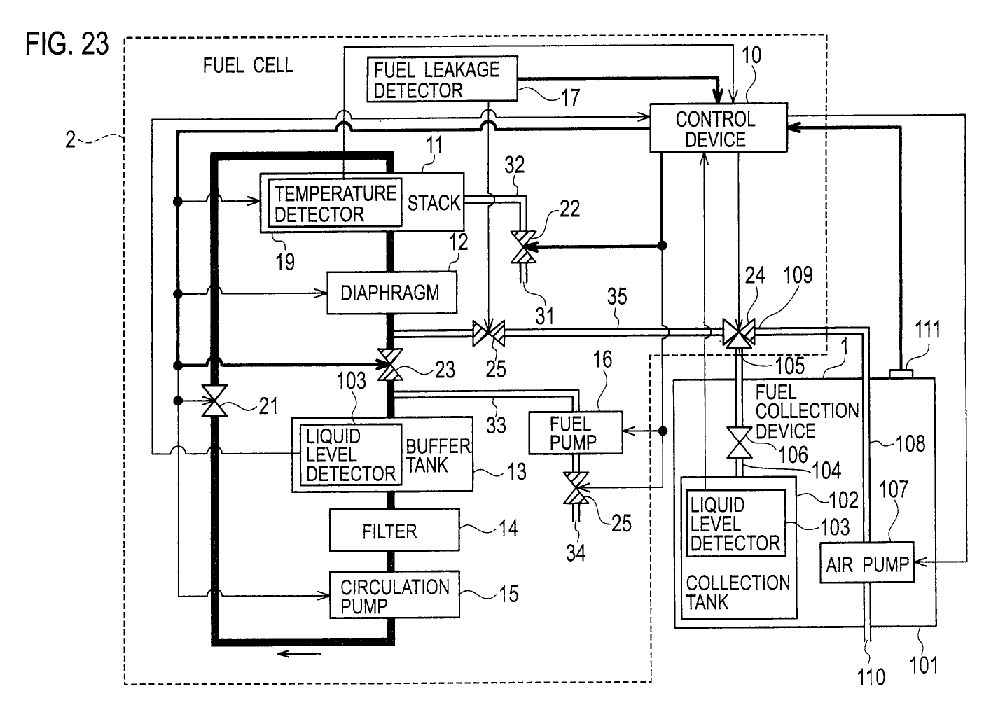

As shown in FIG. 23, each of the fuel cell systems according to the first and second embodiments may include a fuel leakage detector 17 that detects leakage of the fuel. The fuel leakage detector 17 detects the fuel leakage during the collection of the fuel, and notifies the control device 10 of the detected fuel leakage. The fuel leakage detector 17 can be provided, for example, in an inside of a floor surface of a cabinet of the fuel cell 2. Moreover, the fuel cell system may include a temperature detector 19 that detects a temperature of the fuel cell 2. The temperature detector 19 detects the temperature of the fuel cell 2, which is out of a predetermined range, during the collection of the fuel, and notifies the control device 10 of the detected temperature. In the case of having received the notice from the fuel leakage detector 17 or the temperature detector 19, the control device 10 stops the fuel collection operation or displays a warning. In such a way, the user and the checker can safely perform the operations.

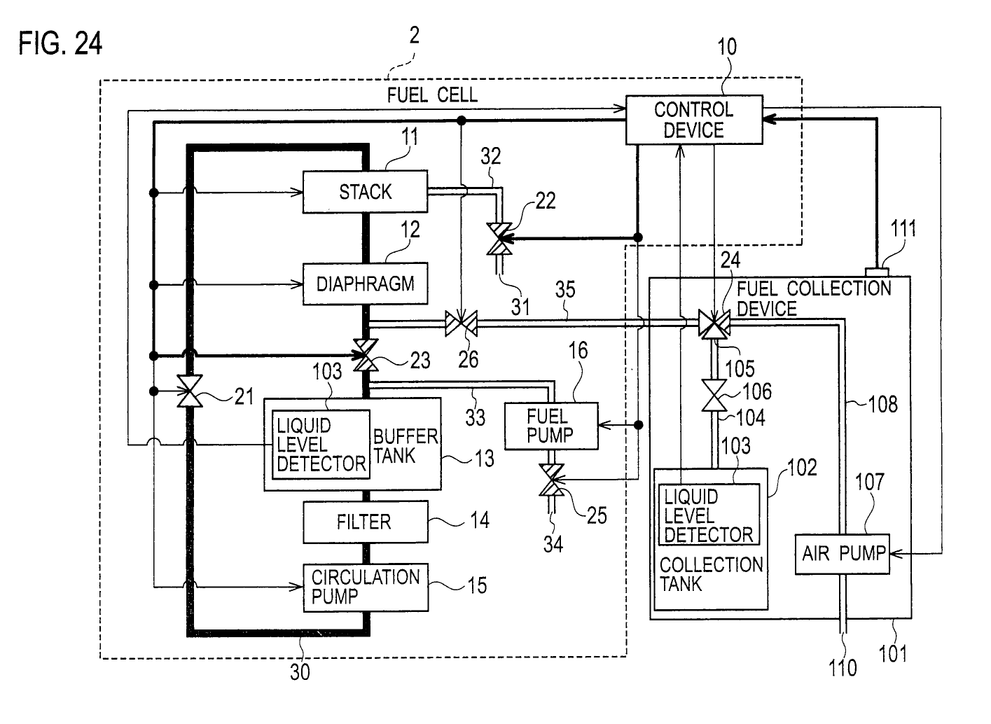

In the first and second embodiments, the description has been made of the case where the switching vale 24 is incorporated into each of the fuel cells 2 and 2x. However, as shown in FIG. 24, the switching valve 24 may be incorporated into the fuel collection device 1 in a state of being connected to the fuel collection port 105 and the air supply port 109. In this case, the switching valve 24 is connected to the branch flow path 35 in the event where the fuel collection device 1 is attached to the fuel cell 2.

The description has been made of the case where the fuel cell system according to each of the first and second embodiments is the DMFC using methanol as the fuel. However, the present invention is applicable to a fuel cell system using, as the fuel, ethanol and others which are not alcohol.

The plurality of constituent components disclosed in the first and second embodiments may be combined with one another as appropriate. Moreover, some constituent components may be deleted from all of the constituent components disclosed in the first and second embodiments.

What is claimed is:

1. A fuel collection device detachably attached a fuel cell, the fuel cell having: a power generation unit generating power by chemically reacting a fuel; a fuel flow path supplying the fuel to the power generation unit; and a circulation pump circulating the fuel in the fuel flow path, the fuel collection device comprising:
a collection tank connected to the fuel flow path, and collecting the fuel in the fuel flow path by driving the circulation pump; and
an air supplier connected to the fuel cell, and supplying an air to the power generation unit.

2. The fuel collection device of claim 1, wherein the fuel collection device further comprises a recognition unit storing information recognizing whether the fuel collection device is applicable for collecting the fuel from the fuel cell.

3. The fuel collection device of claim 2, wherein the recognition unit store a fuel collection operating procedure corresponding to the fuel cell, and
the fuel cell further comprises a control device controlling the circulation pump based on the fuel collection operating procedure.

4. The fuel collection device of claim 1, wherein the fuel cell further comprises an exhaust path exhausting the air supplied to the power generation unit by the air supplier.

5. The fuel collection device of claim 1, wherein the circulation pump has a forward driving mode and a reverse driving mode, and the collection tank collects the fuel in the fuel flow path by reversely driving the circulation pump.

6. The fuel collection device of claim 1, further comprising:
a coloring unit coloring the fuel collected in the collection tank.

7. The fuel collection device of claim 1, further comprising:
a volatile organic compound removal filter removing a volatile organic compound in the fuel discharged from the fuel flow path.

8. The fuel collection device of claim 1, further comprising:
a fuel holding pack contained in the collection tank.

9. A fuel collection device detachably attached a fuel cell, the fuel cell having: a power generation unit generating power by chemically reacting a fuel; a fuel flow path supplying the fuel to the power generation unit; and a circulation pump circulating the fuel in the fuel flow path, the fuel collection device comprising:
a collection tank connected to the fuel flow path, and collecting the fuel in the fuel flow path by driving the circulation pump;
an air supplier connected to the fuel flow path, and supplying an air to the power generation unit; and
a recognition unit recognizing whether the fuel collection device is applicable for collecting the fuel from the fuel cell,
wherein the fuel cell further comprises a control unit controlling: collecting the fuel in the fuel flow path to the collection tank by driving the circulation pump when the recognition unit recognized that the fuel collection device is applicable for collecting the fuel from the fuel cell; and supplying the air to the power generation unit by driving the air supplier.

10. The fuel collection device of claim 9, where in the recognition unit stores a fuel collection operating procedure corresponding to the fuel cell, and
the control device controls the circulation pump based on the fuel collection operating procedure.

11. The fuel collection device of claim 9, wherein the fuel cell further comprises an exhaust path exhausting the air supplied to the power generation unit by the air supplier.

12. The fuel collection device of claim 9, where in the circulation pump has a forward driving mode and a reverse driving mode, and the collection tank collects the fuel in the fuel flow path by reversely driving the circulation pump.

13. The fuel collection device of claim 9, further comprising:
a coloring unit coloring the fuel collected in the collection tank.

14. The fuel collection device of claim 9, further comprising:
a volatile organic compound removal filter removing a volatile organic compound in the fuel discharged from the fuel flow path.

15. The fuel collection device of claim 9, further comprising:
a fuel holding pack contained in the collection tank.
